(19) United States
(12) Patent Application Publication
(10) Pub. No.: US 2026/0307670 A1
(43) Pub. Date: Oct. 8, 2026

(54) INTENT PREDICTION

(71) Applicant: HONDA MOTOR CO., LTD., Tokyo (JP)

(72) Inventors: Nakul AGARWAL, San Francisco, CA (US); Rigved SANKU, Worcester, MA (US); Pero SUBASIC, San Jose, CA (US); Kikuo FUJIMURA, Palo Alto, CA (US); Yuki IWABUCHI, Tokyo (JP); Genki INOHANA, Tokyo (JP); Seonghun LEE, Tokyo (JP)

(21) Appl. No.: 19/465,543

(22) Filed: Jan. 30, 2026

Related U.S. Application Data
(60) Provisional application No. 63/782,414, filed on Apr. 2, 2025.

(51) Int. Cl. B60W 50/10; B60W 50/00; G06V 10/82; G06V 20/58; G06V 20/59; G06V 40/10

(52) U.S. Cl. CPC B60W 50/10; B60W 50/0097; B60W 50/0098; G06V 10/82; G06V 20/58; G06V 20/59; G06V 40/10; B60W 2420/403; B60W 2540/041; B60W 2540/223

(57) ABSTRACT

According to one aspect, intent prediction may include detecting an individual from a set of input image frames, determining a body orientation associated with the individual, determining a head orientation associated with the individual, generating an intent prediction associated with the individual based on the detected individual, the body orientation, the head orientation, and an intent prediction neural network model, and performing a service for the individual using one or more systems or devices based on the intent prediction.

### CROSS-REFERENCE TO RELATED APPLICATIONS

This application claims the benefit of U.S. Provisional Patent Application, Serial No. 63/782414 (Attorney Docket No. H1251052US01) entitled “DRIVER INTENT PREDICTION FOR AUTOMATIC CAR ENTRY AND EXIT SYSTEM”, filed on Apr. 2, 2025; the entirety of the above-noted application(s) is incorporated by reference herein.

### BACKGROUND

Generally, computer vision prediction problems encompass a range of challenges related to accurately interpreting and understanding visual data. These include accurately identifying objects, understanding scenes, and predicting future events based on visual input. Issues often involve data quality, lighting conditions, occlusion, and the need for real-time processing in complex scenarios. Challenges often include occlusion, such as when objects are partially hidden or blocked, it may be challenging to accurately identify and track them. Further, real-time processor may be a challenge because applications may require rapid analysis of visual data, which may be computationally expensive.

### BRIEF DESCRIPTION

According to one aspect, a system for intent prediction may include a processor and a memory. The memory may store one or more instructions. The processor may execute one or more of the instructions stored on the memory to perform one or more acts, actions, and/or steps. The processor may perform detecting an individual from a set of input image frames, determining a body orientation associated with the individual, determining a head orientation associated with the individual, and generating an intent prediction associated with the individual based on the detected individual, the body orientation, the head orientation, and an intent prediction neural network model.

The intent prediction neural network model may include an individual detector intent prediction neural network model, a body orientation intent prediction neural network model, and a head orientation intent prediction neural network model. The processor may generate an individual detector intent prediction based on the individual detector intent prediction neural network model, a body orientation intent prediction based on the body orientation intent prediction neural network model, and a head orientation intent prediction based on the head orientation intent prediction neural network model. The processor may generate the intent prediction associated with the individual based on the individual detector intent prediction, the body orientation intent prediction, and the head orientation intent prediction. For example, the processor may generate the intent prediction associated with the individual by averaging the individual detector intent prediction, the body orientation intent prediction, and the head orientation intent prediction. The processor may generate an input for the intent prediction neural network model by concatenating bounding boxes associated with the detected individual, the body orientation, and the head orientation. The processor may generate the intent prediction associated with the individual based on the input for the intent prediction neural network model. The system for intent prediction may include an image capture device capturing the set of input image frames. The intent prediction associated with the individual may include a prediction of boarding a vehicle or alighting the vehicle. The intent prediction neural network model may be trained during a training phase using a set of training image frames annotated with an intent to board a vehicle.

According to one aspect, a computer-implemented method for intent prediction may include detecting an individual from a set of input image frames, determining a body orientation associated with the individual, determining a head orientation associated with the individual, generating an intent prediction associated with the individual based on the detected individual, the body orientation, the head orientation, and an intent prediction neural network model, and performing a service for the individual using one or more vehicle systems based on the intent prediction.

The intent prediction neural network model may include an individual detector intent prediction neural network model, a body orientation intent prediction neural network model, and a head orientation intent prediction neural network model. The computer-implemented method for intent prediction may include generating an individual detector intent prediction based on the individual detector intent prediction neural network model, a body orientation intent prediction based on the body orientation intent prediction neural network model, and a head orientation intent prediction based on the head orientation intent prediction neural network model. The computer-implemented method for intent prediction may include generating the intent prediction associated with the individual based on the individual detector intent prediction, the body orientation intent prediction, and the head orientation intent prediction. The computer-implemented method for intent prediction may include generating the intent prediction associated with the individual by averaging the individual detector intent prediction, the body orientation intent prediction, and the head orientation intent prediction.

According to one aspect, an intent prediction vehicle may include a processor, a memory, and one or more vehicle systems. The memory may store one or more instructions. The processor may execute one or more of the instructions stored on the memory to perform one or more acts, actions, and/or steps. The processor may perform detecting an individual from a set of input image frames, determining a body orientation associated with the individual, determining a head orientation associated with the individual, and generating an intent prediction associated with the individual based on the detected individual, the body orientation, the head orientation, and an intent prediction neural network model. One or more of the vehicle systems may perform a service for the individual based on the intent prediction.

The intent prediction neural network model may include an individual detector intent prediction neural network model, a body orientation intent prediction neural network model, and a head orientation intent prediction neural network model. The processor may generate an individual detector intent prediction based on the individual detector intent prediction neural network model, a body orientation intent prediction based on the body orientation intent prediction neural network model, and a head orientation intent prediction based on the head orientation intent prediction neural network model. The processor may generate the intent prediction associated with the individual based on the individual detector intent prediction, the body orientation intent prediction, and the head orientation intent prediction. The processor may generate the intent prediction associated with the individual by averaging the individual detector intent prediction, the body orientation intent prediction, and the head orientation intent prediction.

### BRIEF DESCRIPTION OF THE DRAWINGS

FIG. 1 is an exemplary component diagram of a system for intent prediction, according to one aspect.

FIG. 2 is an exemplary component diagram of a computer-implemented method for intent prediction, according to one aspect.

FIGS. 3A-3B are exemplary architectures in association with intent prediction, according to one aspect.

FIGS. 4A-4B are exemplary architectures in association with intent prediction, according to one aspect.

FIG. 5 is an illustration of an example computing environment where one or more of the provisions set forth herein are implemented, according to one aspect.

FIG. 6 is an illustration of an example computer-readable medium or computer-readable device including processor-executable instructions configured to embody one or more of the provisions set forth herein, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “controller”, as used herein, may be a device implemented in hardware, firmware, software, or a combination thereof. A controller may include one or more CPUs (e.g., a central processing unit including one or more "processors"), a "memory", a “storage drive”, a "bus", and one or more programmable input/output (I/O) peripherals.

A "database", as used herein, may refer to a table, a set of tables, and a set of data stores (e.g., disks) and/or methods for accessing and/or manipulating those data stores.

An "operable connection", or a connection by which entities are "operably connected", is one in which signals, physical communications, and/or logical communications may be sent and/or received. An operable connection may include a wireless interface, a physical interface, a data interface, and/or an electrical interface.

A "computer communication", as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “vehicle”, as used herein, refers to any moving vehicle that is capable of carrying one or more human occupants and is powered by any form of energy. The term “vehicle” includes cars, trucks, vans, minivans, SUVs, motorcycles, scooters, boats, personal watercraft, and aircraft. In some scenarios, a motor vehicle includes one or more engines. Further, the term "vehicle" may refer to an electric vehicle (EV) that is powered entirely or partially by one or more electric motors powered by an electric battery. The EV may include battery electric vehicles (BEV) and plug-in hybrid electric vehicles (PHEV). Additionally, the term "vehicle" may refer to an autonomous vehicle and/or self-driving vehicle powered by any form of energy. The autonomous vehicle may or may not carry one or more human occupants.

A "vehicle system", as used herein, may be any automatic or manual systems that may be used to enhance the vehicle, and/or driving. Exemplary vehicle systems include an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, among others.

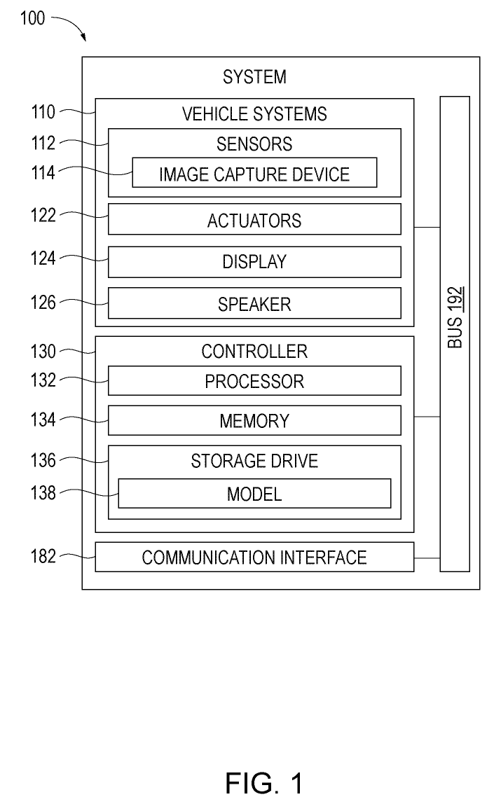

FIG. 1 is an exemplary component diagram of a system 100 for intent prediction, according to one aspect. The system 100 for intent prediction may include one or more vehicle systems 110. For example, one or more of the vehicle systems 110 may include sensors 112, an image capture device 114, actuators 122, a display 124, a speaker 126, etc. The system 100 for intent prediction may include a controller 130 including a processor 132, a memory 134, and a storage drive 136. The storage drive 136 may store one or more models, such as an intent prediction neural network model 138. The system 100 for intent prediction may include a communication interface 182 and a bus 192. The communication interface 182 may receive the intent prediction neural network model 138, which may be trained separate from the system 100 for intent prediction. The bus 192 may form an operable connection between components of the system 100 for intent prediction (e.g., one or more of the vehicle systems 110, the controller 130, the processor 132, the memory 134, the storage drive 136, the communication interface 182, etc.), thereby enabling computer communication therebetween.

According to one aspect, the image capture device 114 may capture a set of input image frames. The memory 134 may store one or more instructions. The processor 132 may execute one or more of the instructions stored on the memory 134 to perform one or more acts, actions, and/or steps. Further, the system 100 for intent prediction may be implemented on a vehicle and/or be an intent prediction vehicle.

### DETECTION OF INDIVIDUAL

The processor 132 may perform detecting an individual from the set of input image frames captured from the image capture device 114. The processor 132 may detect one or more characteristics of the individual, such as where the individual is within a given image frame, how far the individual is from the image capture device 114 or another sensor, etc. Using these characteristics, as well as a model, such as Yolov3, the processor 132 may detect one or more characteristics of the detected individual. According to one aspect, the model for detection of the individual may use predefined anchor boxes to detect objects efficiently and determine a center coordinate for the individual within a bounding box associated with the individual in the given frame (e.g., where the individual is within the given frame) and determine a width and a height associated with the individual. The width and the height associated with the individual may represent how near or far the individual is from the image capture device 114.

### BODY ORIENTATION DETERMINATION

The processor 132 may perform determining a body orientation associated with the individual. In other words, the processor 132 may determine a direction that the individual’s body is facing within a given image frame. For example, the body orientation may be determined using 3D keypoints from MotionBERT and/or AlphaPose. The orientation may be derived via cross products between vectors formed by the shoulder joints and the hip joints of the individual, providing a consistent and interpretable measure of torso direction in space. According to one aspect, MotionBERT may extract 2D poses (e.g., multiple keypoints) from the image frames using AlphaPose or AlphaPose2, trained on a Halpe dataset, combine 2D pose sequences over time to predict 3D human poses, combine 2D pose sequences over time to predict 3D human poses, and compute a body vector using the cross-product of shoulder and hip vectors. In this way, the body orientation vector may be determined that represents a direction of a torso of the individual in 3D space. In other words, the body orientation vector may represent where the individual’s body is facing.

### HEAD ORIENTATION DETERMINATION

The processor 132 may perform determining a head orientation associated with the individual. In other words, the processor 132 may determine a direction that the individual’s head is facing within a given image frame. For example, the head orientation may be determined by deploying WHENet using ONNXRuntime and TensorRT backends to estimate yaw, pitch, and roll angles from cropped head regions. This head pose information may be used to complement the body orientation vectors from the body orientation and enhance downstream behavior understanding. The WHENet model may handle extreme yaw angles (e.g., ±180°), making it robust for non-frontal and back-view head pose estimation. Thus, head pose estimation over head detection outputs may be provided. The head orientation may include a roll, a pitch, a yaw, and represent the head orientation in 3D space (e.g., where the individual’s head is facing).

### INTENT PREDICTION

The processor 132 may perform generating an intent prediction associated with the individual based on the detected individual, the body orientation, the head orientation, and an intent prediction neural network model 138. The intent prediction associated with the individual may include a prediction of boarding a vehicle or alighting the vehicle. The intent prediction neural network model 138 may be trained during a training phase using a set of training image frames annotated with an intent to board a vehicle or an intent to alight the vehicle as ground truth. In this way, intent prediction may be provided to recognize, interpret, and predict an intention of an individual when entering (e.g., boarding) or exiting (e.g., alighting) a vehicle. In this way, the intent prediction may represent an “intent” of the individual for boarding or alighting the vehicle.

According to one aspect, the intent prediction neural network model 138 may include a Long Short-Term Memory (LSTM) based intention recognition model that takes in sequences of body orientation vectors (e.g., from the body orientation information) and outputs predictions, such as whether an individual is likely to enter or exit a vehicle. The intent prediction neural network model 138 may be designed for input preprocessing to ensure consistent alignment with spatial and temporal constraints.

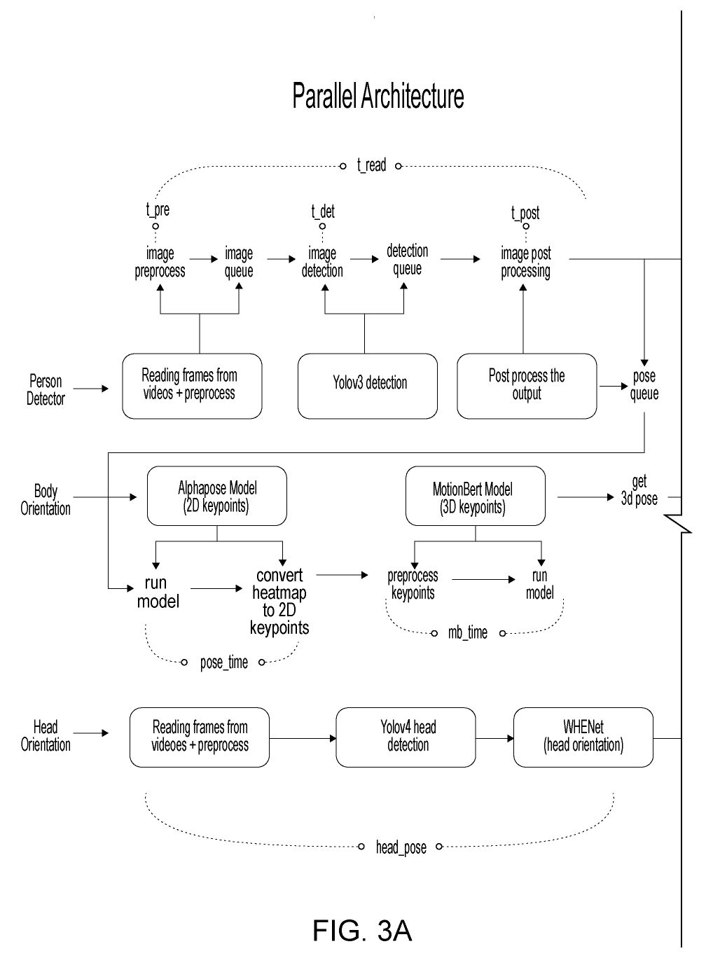

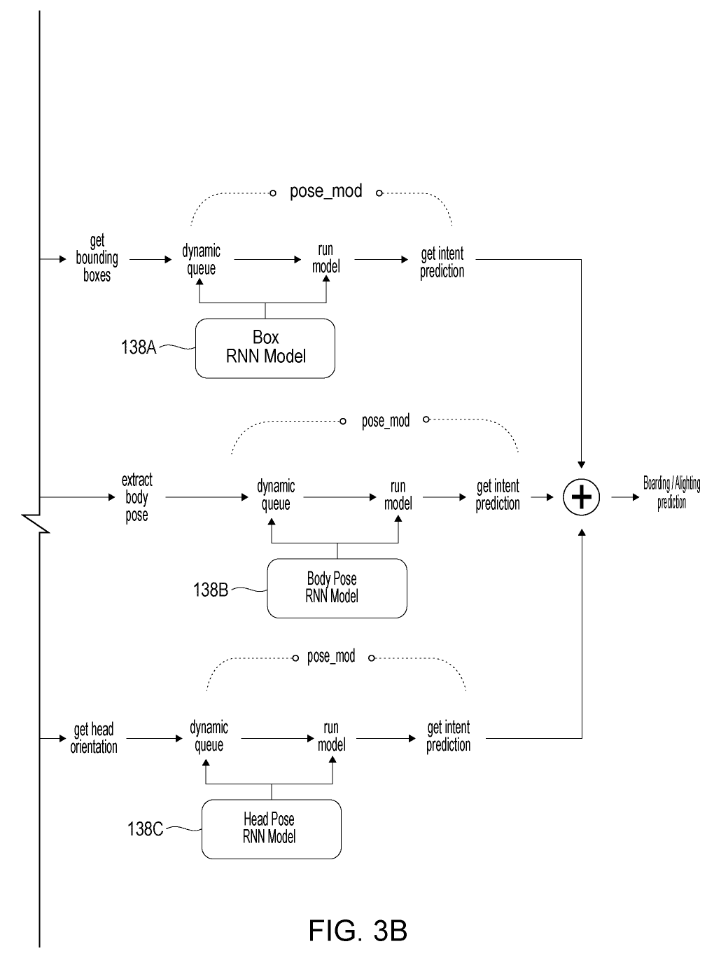

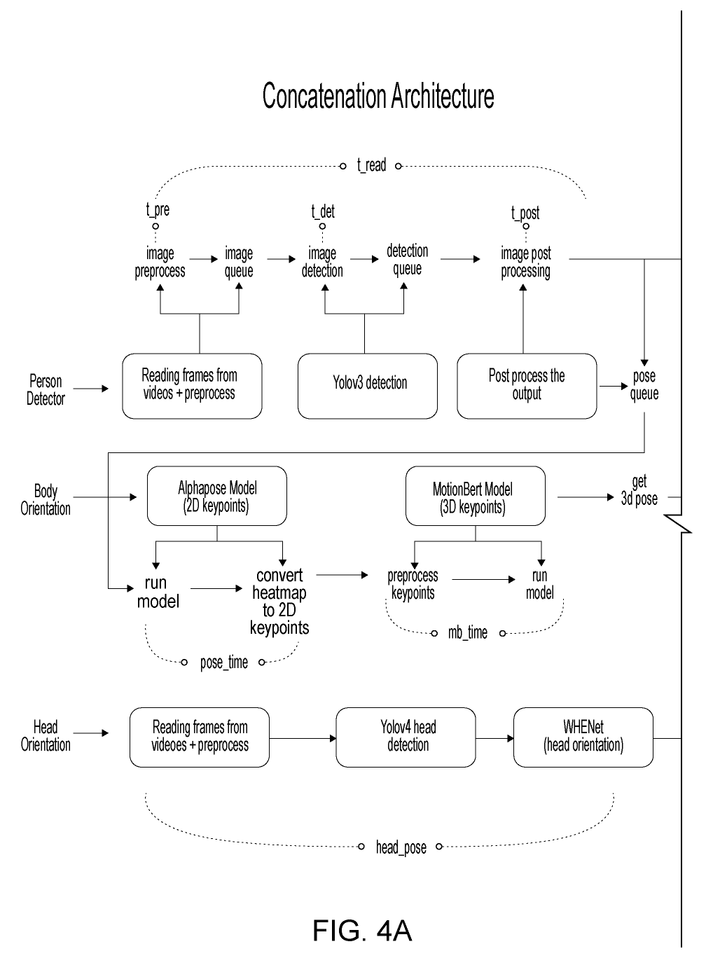

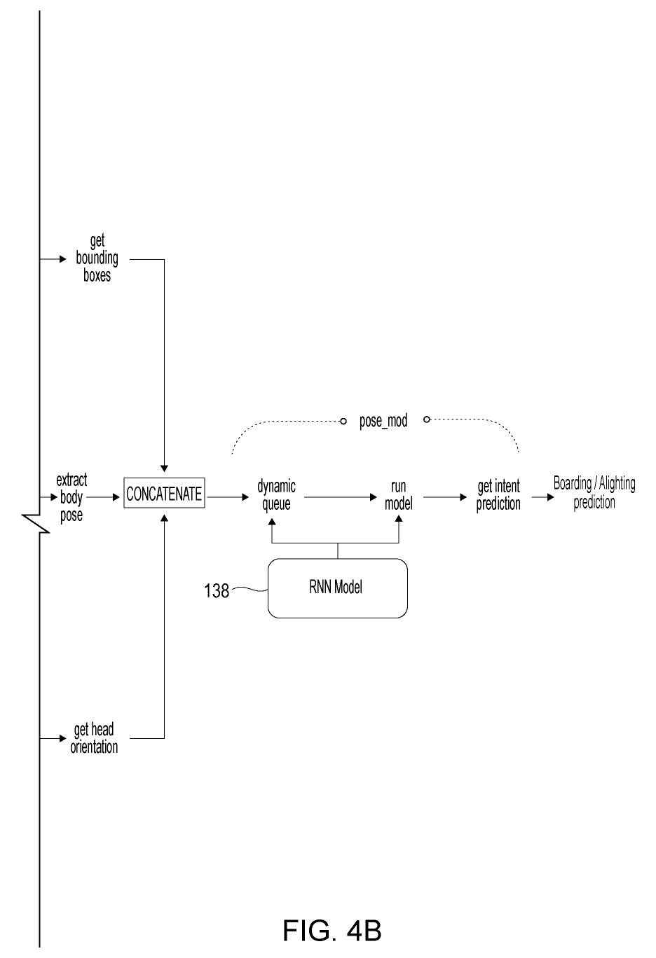

Further, the architectures discussed herein (e.g., FIGS. 3-4) provide the benefit or advantage of enabling the intent prediction to be provided with extremely low latency. Additionally, the architecture of FIGS. 3A-3B may enable intent prediction even when one or more of the modalities is not available (e.g., individual detection, body orientation determination, or head orientation determination).

### INTENT PREDICTION SERVICES

One or more of the vehicle systems 110 may perform a service for the individual based on the intent prediction. For example, the actuator may unlock a door, open a window, start an engine, display 124 a message, play a sound, etc. based on the intent prediction.

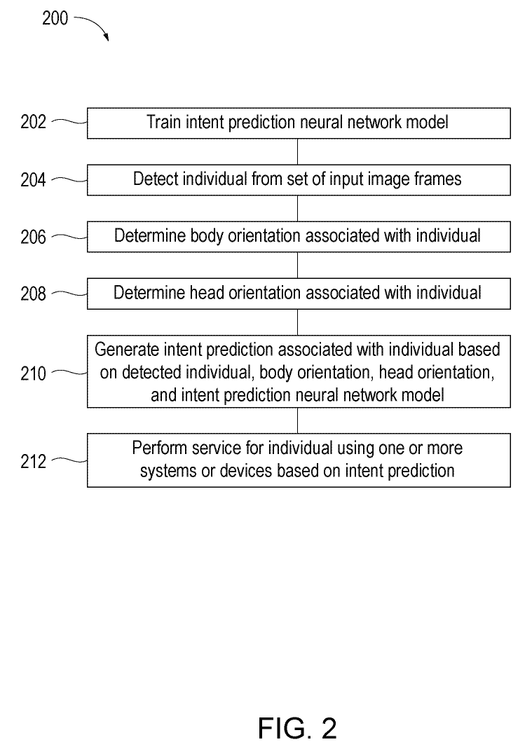

FIG. 2 is an exemplary component diagram of a computer-implemented method 200 for intent prediction, according to one aspect. The computer-implemented method 200 for intent prediction may include training 202 an intent prediction model, detecting 204 an individual from a set of input image frames, determining 206 a body orientation associated with the individual, determining 208 a head orientation associated with the individual, generating 210 an intent prediction associated with the individual based on the detected individual, the body orientation, the head orientation, and an intent prediction neural network model, and performing 212 a service for the individual using one or more vehicle systems based on the intent prediction.

The intent prediction neural network model may include an individual detector intent prediction neural network model, a body orientation intent prediction neural network model, and a head orientation intent prediction neural network model. The computer-implemented method for intent prediction may include generating an individual detector intent prediction based on the individual detector intent prediction neural network model, a body orientation intent prediction based on the body orientation intent prediction neural network model, and a head orientation intent prediction based on the head orientation intent prediction neural network model. The computer-implemented method for intent prediction may include generating the intent prediction associated with the individual based on the individual detector intent prediction, the body orientation intent prediction, and the head orientation intent prediction. The computer-implemented method for intent prediction may include generating the intent prediction associated with the individual by averaging the individual detector intent prediction, the body orientation intent prediction, and the head orientation intent prediction.

### INTENT PREDICTION – PARALLEL ARCHITECTURE

FIGS. 3A-3B are exemplary architectures in association with intent prediction, according to one aspect. The intent prediction neural network model 138 of FIG. 1 may include an individual detector intent prediction neural network model 138A, a body orientation intent prediction neural network model 138B, and a head orientation intent prediction neural network model 138C. The processor may generate an individual detector intent prediction based on the individual detector intent prediction neural network model 138A, a body orientation intent prediction based on the body orientation intent prediction neural network model 138B, and a head orientation intent prediction based on the head orientation intent prediction neural network model 138C. The processor may generate the intent prediction associated with the individual based on the individual detector intent prediction, the body orientation intent prediction, and the head orientation intent prediction. For example, the processor may generate the intent prediction associated with the individual by averaging the individual detector intent prediction, the body orientation intent prediction, and the head orientation intent prediction.

Due to the parallelism of this architecture, each stream runs independently but concurrently. These streams do not block or wait for each other, allowing them to advantageously process frames simultaneously. This separation leads to modular design, where each characteristic determined (e.g., individual detection, body orientation via MotionBERT, or head orientation via WHENet) may be optimized, replaced, or executed on separate threads, GPUs, etc. independently. The result is a faster inference pipeline for intent prediction, where computational resources are better utilized without bottlenecks between stages.

Yet another advantage is that this architecture is robust to missing data because it combines spatial, pose, and attention cues for more accurate human intent understanding. The final intent prediction benefits from the average of multiple perspectives. It makes it more robust to occlusions or missing data in one stream (e.g., if body pose is unreliable in one frame, head orientation or box motion may still suffice).

### INTENT PREDICTION – CONCATENATION ARCHITECTURE

FIGS. 4A-4B are exemplary architectures in association with intent prediction, according to one aspect. According to this aspect, the processor may generate an input for the intent prediction neural network model 138 by concatenating bounding boxes associated with the detected individual, the body orientation, and the head orientation. The processor may generate the intent prediction associated with the individual based on feeding the input for the intent prediction neural network model 138 through the intent prediction neural network model 138.

In this way, the architectures of FIGS. 3-4 may include a modular and extensible pipeline combining multiple stages of human behavior perception; 2D pose estimation (e.g., AlphaPose), 3D pose estimation (e.g., MotionBERT), and head pose estimation (e.g., WHENet). According to one aspect, the architectures may be optimized by converting one or more models (e.g., Yolo, AlphaPose, AlphaPose2, MotionBERT, WHENet, etc.) from PyTorch and ONNX formats to optimized TensorRT engines. This provides the benefit or advantage of a low-latency inference with significantly reduced computational overhead, making the system suitable for real-time applications on embedded or GPU-constrained devices.

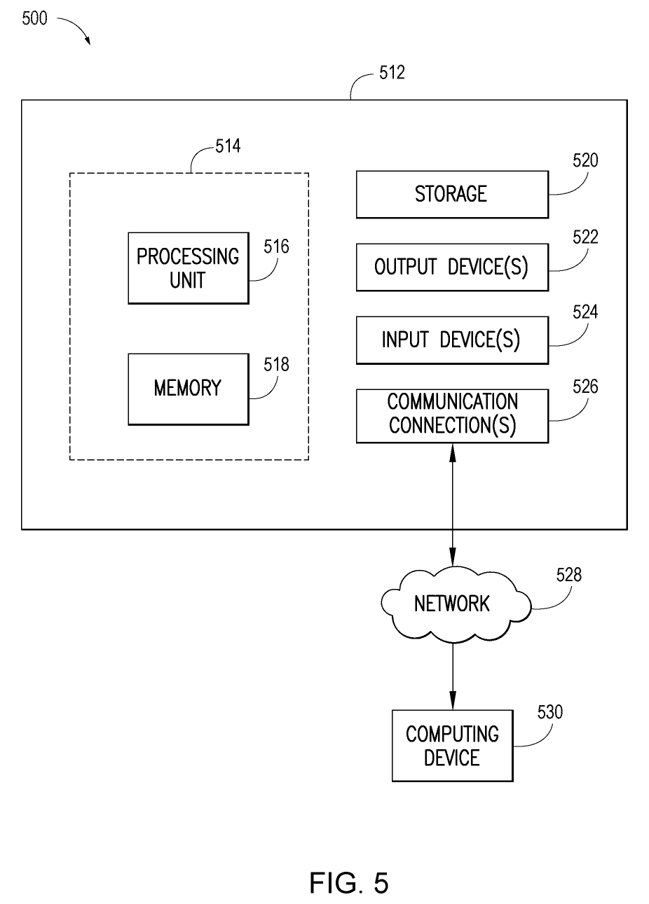

FIG. 5 and the following discussion provide a description of a suitable computing environment to implement aspects of one or more of the provisions set forth herein. The operating environment of FIG. 5 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 5 illustrates a system 500 including a computing device 512 configured to implement one aspect provided herein. In one configuration, the computing device 512 includes at least one processing unit 516 and memory 518. Depending on the exact configuration and type of computing device, memory 518 may be volatile, such as RAM, non-volatile, such as ROM, flash memory, etc., or a combination of the two. This configuration is illustrated in FIG. 5 by dashed line 514.

In other aspects, the computing device 512 includes additional features or functionality. For example, the computing device 512 may include additional storage such as removable storage or non-removable storage, including, but not limited to, magnetic storage, optical storage, etc. Such additional storage is illustrated in FIG. 5 by storage 520. In one aspect, computer readable instructions to implement one aspect provided herein are in storage 520. Storage 520 may store other computer readable instructions to implement an operating system, an application program, etc. Computer readable instructions may be loaded in memory 518 for execution by the at least one processing unit 516, for example.

The term “computer readable media” as used herein includes computer storage media. Computer storage media includes volatile and nonvolatile, removable, and non-removable media implemented in any method or technology for storage of information such as computer readable instructions or other data. Memory 518 and storage 520 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 512. Any such computer storage media is part of the computing device 512.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 512 includes input device(s) 524 such as keyboard, mouse, pen, voice input device, touch input device, infrared cameras, video input devices, or any other input device. Output device(s) 522 such as one or more displays, speakers, printers, or any other output device may be included with the computing device 512. Input device(s) 524 and output device(s) 522 may be connected to the computing device 512 via a wired connection, wireless connection, or any combination thereof. In one aspect, an input device or an output device from another computing device may be used as input device(s) 524 or output device(s) 522 for the computing device 512. The computing device 512 may include communication connection(s) 526 to facilitate communications with one or more other devices 530, such as through network 528, for example.

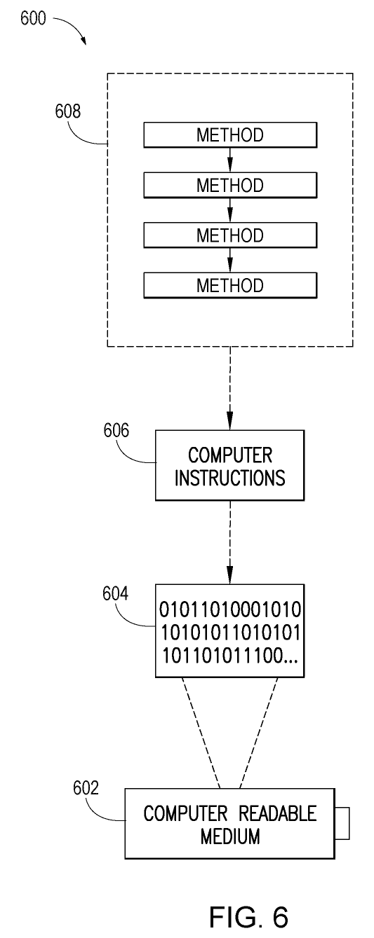

Still another aspect involves a computer-readable medium including processor-executable instructions configured to implement one aspect of the techniques presented herein. An aspect of a computer-readable medium or a computer-readable device devised in these ways is illustrated in FIG. 6, wherein an implementation 600 includes a computer-readable medium 602, such as a CD-R, DVD-R, flash drive, a platter of a hard disk drive, etc., on which is encoded computer-readable data 604. This encoded computer-readable data 604, such as binary data including a plurality of zero’s and one’s as shown in 604, in turn includes a set of processor-executable computer instructions 606 configured to operate according to one or more of the principles set forth herein. In this implementation 600, the processor-executable computer instructions 606 may be configured to perform a method 608, such as the computer-implemented method 200 for intent prediction of FIG. 2. In another aspect, the processor-executable computer instructions 606 may be configured to implement a system, such as the system 100 for intent prediction of FIG. 1. Many such computer-readable media may be devised by those of ordinary skill in the art that are configured to operate in accordance with the techniques presented herein.

As used in this application, the terms "component”, "module," "system", "interface", and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term "article of manufacture" as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, "or" is intended to mean an inclusive "or" rather than an exclusive "or". Further, an inclusive “or” may include any combination thereof (e.g., A, B, or any combination thereof). In addition, "a" and "an" as used in this application are generally construed to mean "one or more" unless specified otherwise or clear from context to be directed to a singular form. Additionally, at least one of A and B and/or the like generally means A or B or both A and B. Further, to the extent that "includes", "having", "has", "with", or variants thereof are used in either the detailed description or the claims, such terms are intended to be inclusive in a manner similar to the term "comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A system for intent prediction, comprising:
a memory storing one or more instructions; and
a processor executing one or more of the instructions stored on the memory to perform:
detecting an individual from a set of input image frames;
determining a body orientation associated with the individual;
determining a head orientation associated with the individual; and
generating an intent prediction associated with the individual based on the detected individual, the body orientation, the head orientation, and an intent prediction neural network model.

2. The system for intent prediction of claim 1, wherein the intent prediction neural network model includes an individual detector intent prediction neural network model, a body orientation intent prediction neural network model, and a head orientation intent prediction neural network model.

3. The system for intent prediction of claim 2, wherein the processor generates an individual detector intent prediction based on the individual detector intent prediction neural network model, a body orientation intent prediction based on the body orientation intent prediction neural network model, and a head orientation intent prediction based on the head orientation intent prediction neural network model.

4. The system for intent prediction of claim 3, wherein the processor generates the intent prediction associated with the individual based on the individual detector intent prediction, the body orientation intent prediction, and the head orientation intent prediction.

5. The system for intent prediction of claim 4, wherein the processor generates the intent prediction associated with the individual by averaging the individual detector intent prediction, the body orientation intent prediction, and the head orientation intent prediction.

6. The system for intent prediction of claim 1, wherein the processor generates an input for the intent prediction neural network model by concatenating bounding boxes associated with the detected individual, the body orientation, and the head orientation.

7. The system for intent prediction of claim 6, wherein the processor generates the intent prediction associated with the individual based on the input for the intent prediction neural network model.

8. The system for intent prediction of claim 1, comprising an image capture device capturing the set of input image frames.

9. The system for intent prediction of claim 1, wherein the intent prediction associated with the individual includes a prediction of boarding a vehicle or alighting the vehicle.

10. The system for intent prediction of claim 1, wherein the intent prediction neural network model is trained during a training phase using a set of training image frames annotated with an intent to board a vehicle.

11. A computer-implemented method for intent prediction, comprising:
detecting an individual from a set of input image frames;
determining a body orientation associated with the individual;
determining a head orientation associated with the individual;
generating an intent prediction associated with the individual based on the detected individual, the body orientation, the head orientation, and an intent prediction neural network model; and
performing a service for the individual using one or more vehicle systems based on the intent prediction.

12. The computer-implemented method for intent prediction of claim 11, wherein the intent prediction neural network model includes an individual detector intent prediction neural network model, a body orientation intent prediction neural network model, and a head orientation intent prediction neural network model.

13. The computer-implemented method for intent prediction of claim 12, comprising generating an individual detector intent prediction based on the individual detector intent prediction neural network model, a body orientation intent prediction based on the body orientation intent prediction neural network model, and a head orientation intent prediction based on the head orientation intent prediction neural network model.

14. The computer-implemented method for intent prediction of claim 13, comprising generating the intent prediction associated with the individual based on the individual detector intent prediction, the body orientation intent prediction, and the head orientation intent prediction.

15. The computer-implemented method for intent prediction of claim 14, comprising generating the intent prediction associated with the individual by averaging the individual detector intent prediction, the body orientation intent prediction, and the head orientation intent prediction.

16. An intent prediction vehicle, comprising:
a memory storing one or more instructions;
a processor executing one or more of the instructions stored on the memory to perform:
detecting an individual from a set of input image frames;
determining a body orientation associated with the individual;
determining a head orientation associated with the individual; and
generating an intent prediction associated with the individual based on the detected individual, the body orientation, the head orientation, and an intent prediction neural network model; and
one or more vehicle systems performing a service for the individual based on the intent prediction.

17. The intent prediction vehicle of claim 16, wherein the intent prediction neural network model includes an individual detector intent prediction neural network model, a body orientation intent prediction neural network model, and a head orientation intent prediction neural network model.

18. The intent prediction vehicle of claim 17, wherein the processor generates an individual detector intent prediction based on the individual detector intent prediction neural network model, a body orientation intent prediction based on the body orientation intent prediction neural network model, and a head orientation intent prediction based on the head orientation intent prediction neural network model.

19. The intent prediction vehicle of claim 18, wherein the processor generates the intent prediction associated with the individual based on the individual detector intent prediction, the body orientation intent prediction, and the head orientation intent prediction.

20. The intent prediction vehicle of claim 19, wherein the processor generates the intent prediction associated with the individual by averaging the individual detector intent prediction, the body orientation intent prediction, and the head orientation intent prediction.
